(19) United States
(12) Patent Application Publication
(10) Pub. No.: US 2013/0050127 A1
(43) Pub. Date: Feb. 28, 2013

(54) ELECTRONIC APPARATUS

(71) Applicant: Kabushiki Kaisha Toshiba, Tokyo (JP)

(72) Inventor: Hajime SUZUKAWA, Hino-shi (JP)

(73) Assignee: KABUSHIKI KAISHA TOSHIBA, Tokyo (JP)

(21) Appl. No.: 13/661,992

(22) Filed: Oct. 26, 2012

Related U.S. Application Data
(63) Continuation of application No. 12/964,509, filed on Dec. 9, 2010.

(30) Foreign Application Priority Data
Dec. 11, 2009 (JP) 2009-282109

(51) Int. Cl. G06F 3/041

(52) U.S. Cl. 345/173

(57) ABSTRACT

According to one embodiment, an electronic apparatus includes a first touch panel and a second touch panel, a display device, a detection module, a setting module, a processor, and a display module. The detection module is configured to detect a predetermined operation on the first touch panel. The setting module is configured to set a process mode corresponding to the predetermined operation when the predetermined operation is detected by the detection module. The processor is configured to execute a process corresponding to the process mode in accordance with an operation on the second touch panel. The display module is configured to display on the display device a result of the process by the processor.

### CROSS-REFERENCE TO RELATED APPLICATIONS

This application is a continuation of U.S. patent application Ser. No. 12/964,509, filed Dec. 9, 2010, which is based upon and claims the benefit of priority from Japanese Patent Application No. 2009-282109, filed Dec. 11, 2009, the entire contents of each of which are incorporated herein by reference.

### FIELD

Embodiments described herein relate generally to an electronic apparatus including a touch panel.

### BACKGROUND

Conventionally, there is known a touch panel apparatus wherein even when a plurality of touch panels are attached to a multi-display system, the touch panels can integrally be operated.

Jpn. Pat. Appin. KOKAI Publication No. H11-161426, for example, discloses a touch panel apparatus wherein physical coordinates representative of a pressed position on a touch panel are sent to a touch panel driver via a touch panel controller. The touch panel driver converts the touch panel physical coordinates to virtual coordinates adaptive to the operating system of a host computer. In the conventional touch panel apparatus, when the coordinates are converted, memory areas of virtual coordinates are allocated to two touch panels, and thereby the two touch panels can integrally be operated.

However, in the prior art, although the two touch panels can integrally be operated, it is merely assumed that each of the touch panels is individually operated.

In general, operations on the touch panel include not only an operation of pressing (pointing) a specific position, but also an operation of moving a position which is being pressed. For example, like a drag-and-drop operation for use with a pointing device such as a mouse, an object (e.g. an icon representing a folder or a file, a menu, or a button) on the display is pressed, the object is moved while the object is being pressed, and then the pressed object is released. Thereby, the movement of the object can be instructed.

However, in the case where two touch panels are independently constructed, it is not possible to continuously move an object while pressing the object between the two touch panels. In the prior art, for example, an object is designated and a command menu is displayed by an operation on one of the touch panels. After designating, e.g. a move command from the command menu, it is necessary to perform an operation of, e.g. pressing (pointing) a position at a destination of move on the other touch panel. Thus, compared to the case of using a single touch panel, the operability is lower.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary external appearance view showing an example of the structure of an electronic apparatus in an embodiment;

FIG. 2 is an exemplary block diagram showing an example of the system configuration of a personal computer in the embodiment;

FIG. 3 is an exemplary block diagram showing an example of the relationship between software components relating to touch panels in the embodiment;

FIG. 4 is an exemplary flow chart illustrating an example of a process for setting a process mode by a first method in the embodiment;

FIG. 5 is an exemplary view showing an example of an icon representing a folder, which is displayed on an LCD in the embodiment;

FIG. 6 is an exemplary view showing an example of an operation by the first method in the embodiment;

FIG. 7 is an exemplary flow chart illustrating an example of a process for setting a process mode by a second method in the embodiment;

FIG. 8 is an exemplary view showing a display example of an icon for describing the second method in the embodiment;

FIG. 9 is an exemplary view showing a display example of the icon for describing the second method in the embodiment;

FIG. 10 is an exemplary view showing a display example of the icon for describing the second method in the embodiment;

FIG. 11 is an exemplary view showing a display example of the icon for describing the second method in the embodiment;

FIG. 12 is an exemplary flow chart illustrating an example of a process for setting a process mode by a third method in the embodiment;

FIG. 13 is an exemplary view illustrating an operation by the third method in the embodiment;

FIG. 14 is an exemplary flow chart illustrating an example of a process for setting a process mode by a fourth method in the embodiment;

FIG. 15 is an exemplary view showing a display example of an icon for describing the fourth method in the embodiment;

FIG. 16 is an exemplary view showing a display example of the icon for describing the fourth method in the embodiment;

FIG. 17 is an exemplary flow chart illustrating an example of a process for setting a process mode by a fifth method in the embodiment; and

FIG. 18 is an exemplary side view showing an example of a touch panel which is equipped with a pressure sensor in the embodiment.

### DETAILED DESCRIPTION

Various embodiments will be described hereinafter with reference to the accompanying drawings.

In general, according to one embodiment, an electronic apparatus comprises a first touch panel and a second touch panel, a display device, a detection module, a setting module, a processor, and a display module. The detection module is configured to detect a predetermined operation on the first touch panel. The setting module is configured to set a process mode corresponding to the predetermined operation when the predetermined operation is detected by the detection module. The processor is configured to execute a process corresponding to the process mode in accordance with an operation on the second touch panel. The display module is configured to display on the display device a result of the process by the processor.

An embodiment will now be described with reference to the accompanying drawings.

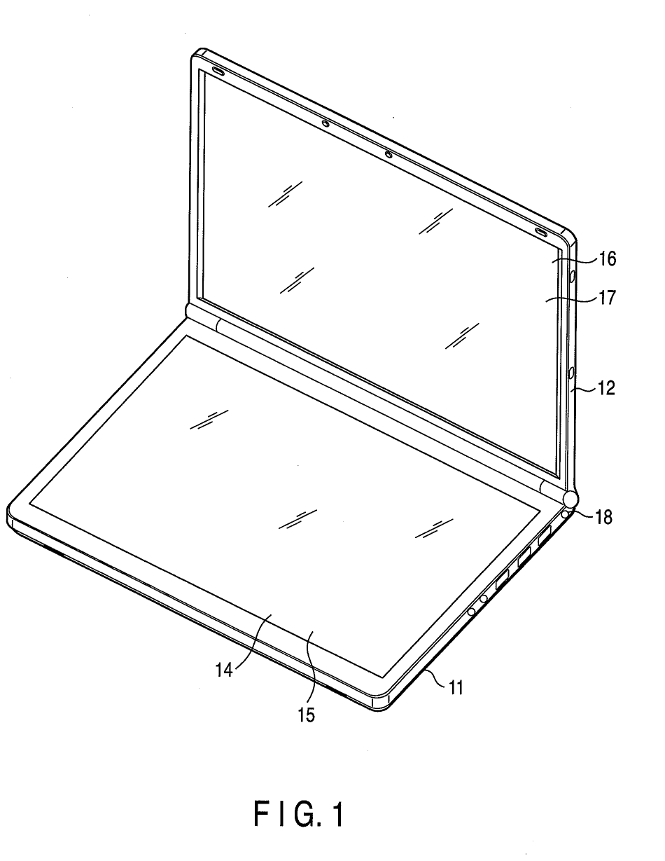

FIG. 1 is an external appearance view showing the structure of an electronic apparatus according to an embodiment. This electronic apparatus is realized, for example, as a notebook-type portable personal computer 10. The personal computer 10 in the embodiments can be driven not only by an external power supply (AC power supply), but also by a battery.

FIG. 1 is an exemplary perspective view showing the personal computer 10 in an open state. The personal computer 10 is configured such that a first display unit 11 and a second display unit 12 are coupled by a hinge mechanism.

A display device which is composed of an LCD (Liquid Crystal Display) 14 is built in the first display unit 11. A display screen of the LCD 14 is disposed at a substantially central part of the first display unit 11. A transmissive touch panel 15 is laid over the display screen of the LCD 14. Thus, various objects (icons representing folders and files, menus, buttons, etc.) which are displayed on the LCD 14 can be viewed through the touch panel 15. By directly designating (pointing) an object displayed on the LCD 14 by a fingertip or a pen, the coordinate data corresponding to the position of the object can be input from the touch panel 15.

The second display unit 12 is constructed like the first display unit 11. Specifically, an LCD 16 is built in the second display unit 12. A transmissive touch panel 17 is laid over the display screen of the LCD 16. In the meantime, the touch panel 15, 17 may be equipped with a pressure sensor 15a, 17a (see FIG. 18).

The second display unit 12 is rotatable, relative to the first display unit 11, between an open position and a closed position by the hinge mechanism. The hinge mechanism can set, for example, the angle between the first display unit 11 and the second display unit 12 at 180° so that the first display unit 11 and the second display unit 12 are disposed in a flat shape. Thereby, the first display unit 11 and the second display unit 12 can be placed on a table, etc., and can be used like a single touch panel.

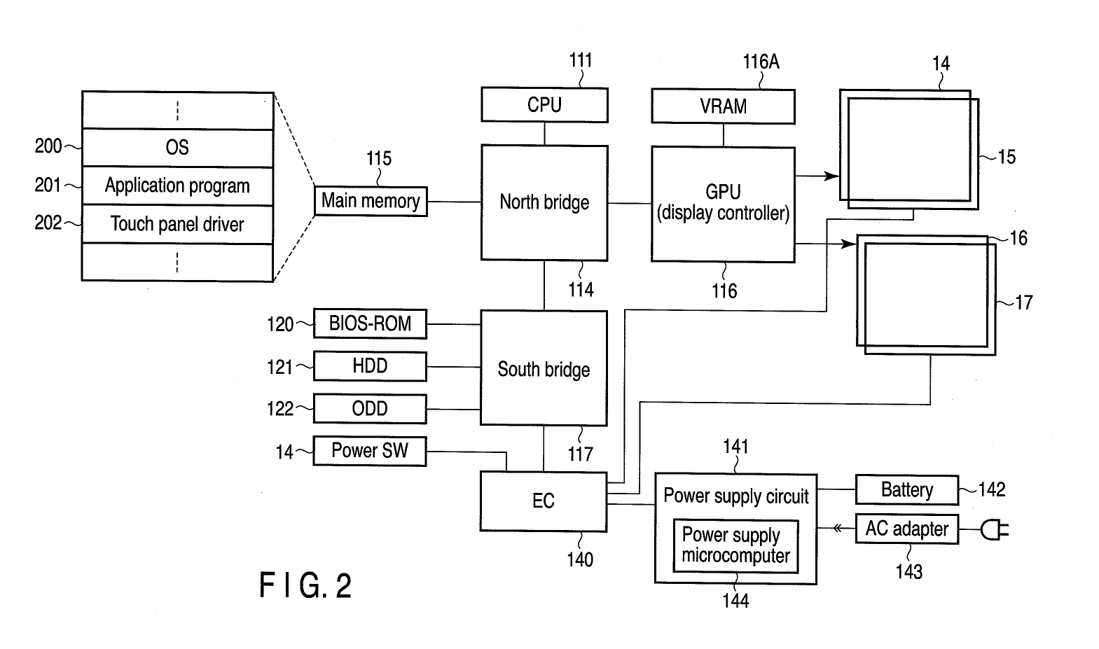

The first display unit 11 is a computer main body, and principal units are mounted in the housing of the first display unit 11. A side surface of the first display unit 11 is provided with a power button switch 18 for power-on/off, and various terminals. A battery 142 (shown in FIG. 2) is detachably attached to the bottom part of the first display unit 11. The first display unit 11 is provided with a power connector (not shown) to which an AC adapter 143 (shown in FIG. 2) can be connected.

FIG. 2 is an exemplary block diagram showing the system configuration of the personal computer 10 in the embodiment.

As shown in FIG. 2, the personal computer 10 includes a CPU 111, a north bridge 114, a main memory 115, a graphics processing unit (GPU) 116, a south bridge 117, a BIOS-ROM 120, a hard disk drive (HDD) 121, an optical disc drive (ODD) 122, an embedded controller IC (EC) 140, and a power supply circuit 141.

The CPU 111 is a processor which is provided in order to control the operation of the personal computer 10. The CPU 111 executes an operating system (OS) 200 and various application programs 201, etc., which are loaded from the HDD 121 into the main memory 115. In addition, the CPU 111 executes a touch panel driver 202 for controlling the touch panels 15 and 17.

Further, the CPU 111 also executes a system BIOS (Basic Input/Output System) which is stored in the BIOS-ROM 120. The system BIOS is a program for hardware control.

The north bridge 114 is a bridge device which connects a local bus of the CPU 111 and the south bridge 117. The north bridge 114 includes a memory controller which access-controls the main memory 115.

The GPU 116 is a display controller for controlling the LCDs 14 and 15 which are used as a display monitor of the personal computer 10. The GPU 116 executes a display process (graphics arithmetic process) for drawing frames on a video memory (VRAM) 116A, based on a drawing request which is sent from CPU 111 via the north bridge 114.

The south bridge 117 incorporates an IDE (Integrated Drive Electronics) controller and a Serial ATA controller for controlling the HDD 121 and optical disc drive (ODD) 122.

The embedded controller IC (EC) 140 is a one-chip microcomputer in which a controller for power management and a controller for controlling the touch panels 15 and 17 are integrated. The EC 140 has a function of powering on/off the personal computer 10 in response to the user's operation of the power button switch 18. The power-on/off control of the personal computer 10 is executed by the cooperation between the EC 140 and power supply circuit 141.

The power supply circuit 141 generates operation power to the respective components by using power from the battery 142 which is attached to the computer main body 11, or power from an external power supply which is connected via the AC adapter 143. The power supply circuit 141 is provided with a power supply microcomputer 144. The power supply microcomputer 144 monitors the power supply (charge/discharge) to the respective components and battery 142, and the charging state of the battery 142. When the battery 142 and AC adapter 143 are connected, the power supply circuit 141 charges the battery 142 by the external power supply.

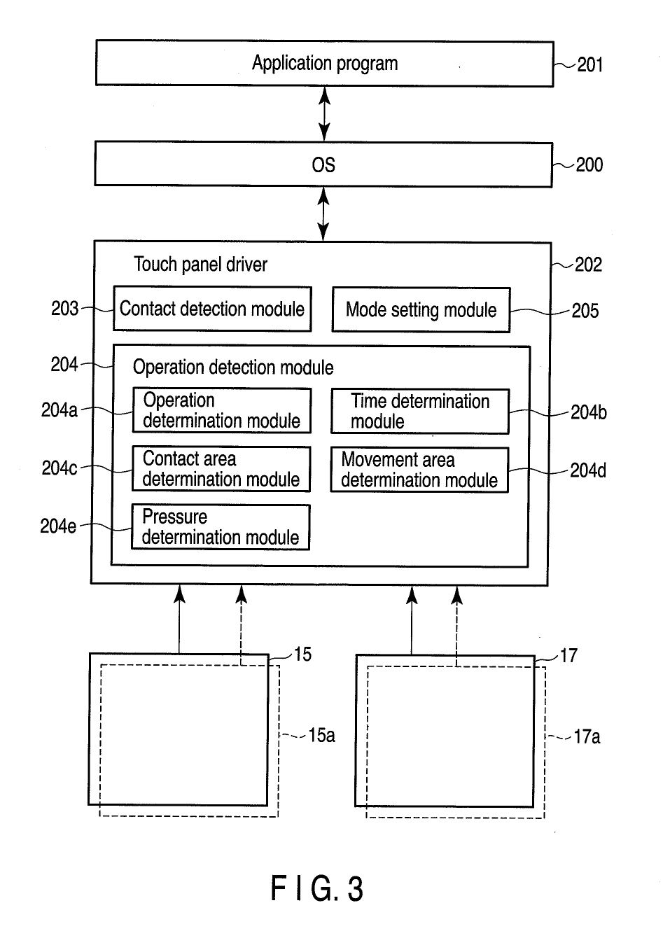

FIG. 3 is an exemplary block diagram showing an example of the relationship between software components relating to the touch panels 15 and 17 in the embodiment. FIG. 3 illustrates an example of controlling the user's operations on the touch panels 15 and 17 by the touch panel driver 202. In the meantime, such configuration may be adopted that the same control is executed by the OS 200 or application program 201.

The touch panels 15 and 17 are controlled by the touch panel driver 202. The touch panel driver 202 includes a contact detection module 203, an operation detection module 204 and a mode setting module 205.

The contact detection module 203 detects contact with the touch panel 15, 17 by the user's operation, and detects coordinate data of the contact position. When the touch panel 15, 17 is touched at a plurality of positions at the same time, the contact detection module 203 can detect coordinate data of the plural positions.

The operation detection module 204 detects a specific operation of designating a process mode, based on the data of the contact position detected by the contact detection module 203. Examples of the process mode include a move mode and a copy mode for an object displayed on the LCD 14, 16. When an object (folder, icon, etc.) that is a target of move or copy is present at a position at which contact has been detected and the execution of a specific operation has been determined, the operation detection module 204 determines that the process mode of a process for the object has been designated. It is assumed that the operation detection module 204 can determine, by inquiring of the OS 200, whether the object is present at the position where contact has been detected by the contact detection module 203.

The operation detection module 204 includes an operation determination module 204a, a time determination module 204b, a contact area determination module 204c, a movement area determination module 204d and a pressure determination module 204e.

The operation determination module 204a determines an operation of moving a first position and a second position of contact with the touch panel 15, 17 to a position corresponding to an object displayed on the LCD 14, 16, and setting the distance between the moved first position and second position to fall within a specific range. For example, the process mode can be designated by performing an operation of pinching the object at the position corresponding to the displayed object.

The time determination module 204b determines an operation in which a position of contact with the touch panel 15, 17 is a position corresponding to an object displayed on the LCD 14, 16 and the time of contact is a predetermined period or more.

The contact area determination module 204c determines an operation in which a position of contact with the touch panel 15, 17 is a position corresponding to an object displayed on the LCD 14, 16 and a contact area is a predetermined value or more or a ratio of increase of the contact area is a predetermined value or more.

The movement area determination module 204d determines an operation in which a first position corresponding to an object displayed on the LCD 14, 16 is touched on the touch panel 15, 17 and the first position, while being touched, is moved to a second position within a preset specific range on the same touch panel, that is, an operation in which the object is moved into the specific range by a so-called drag operation.

The pressure determination module 204e reads a pressure value detected by the pressure sensor 15a, 17a which is attached to the touch panel 15, 17, and determines an operation in which the pressure of contact detected by the touch panel 15, 17 is a predetermined value or more.

The mode setting module 205 sets the process mode according to the operation detected by the operation detection module 204. For example, the operation detected by the operation detection module 204 is the operation for moving the object, the mode setting module 205 sets a move mode. In accordance with an operation on the touch panel 15, 17, which is detected after the process mode is set, the mode setting module 205 requests the OS 200 (or application program 201) to execute a process corresponding to the process mode.

The OS 200 or application program 201 executes a process corresponding to the operation on the touch panel 15, 17, which is detected by the touch panel driver 202. The OS 200 manages the display position of an object (e.g. an icon representing a folder or a file, a menu, a button, a display window of each application, etc.) displayed on the LCD 14, 16. Responding to an inquiry from the touch panel driver 202, the OS 200 can report whether an object is present at a contact position on the touch panel 15, 17, which is detected by the touch panel driver 202.

In addition, the OS 200 or application program 201 can execute a process based on the coordinate data of a plurality of positions of simultaneous contact with the touch panel, 15, 17, which are detected by the touch panel driver 202 (contact detection module 203).

In FIG. 3, the user's operation on the touch panel 15, 17 is determined by the touch panel driver 202, and the process mode is set. Alternatively, the user's operation may be determined by the OS 200 or application program 201, and the process mode corresponding to the determined operation may be set. In this case, the touch panel driver 202 executes the process of informing the OS 200 of the coordinate data detected by the user's operation on the touch panel 15, 17.

Next, the operation of the personal computer 10 in the embodiment is described.

The personal computer 10 can display, by the control of the OS 200, a single screen on, for example, two LCDs 14 and 16, or independent screens (e.g. screens of individual applications) on the two LCDs 14 and 16. In the description below, the case is described, by way of example, where a folder (or a file) displayed on one LCD 14 is moved to the other LCD 16 by an operation on the touch panel 15, 17.

In the personal computer 10 in the embodiment, the process mode (move mode) is set by first to fifth methods, which will be described below, and the process of moving the folder (file) can be executed. However, in the personal computer 10 in the embodiment, the process mode may be set by any one of the first to fifth methods, or by an arbitrary combination of two or more of the first to fifth methods.

(1) Method (first method) in which the process mode is set by an operation of pinching an object.

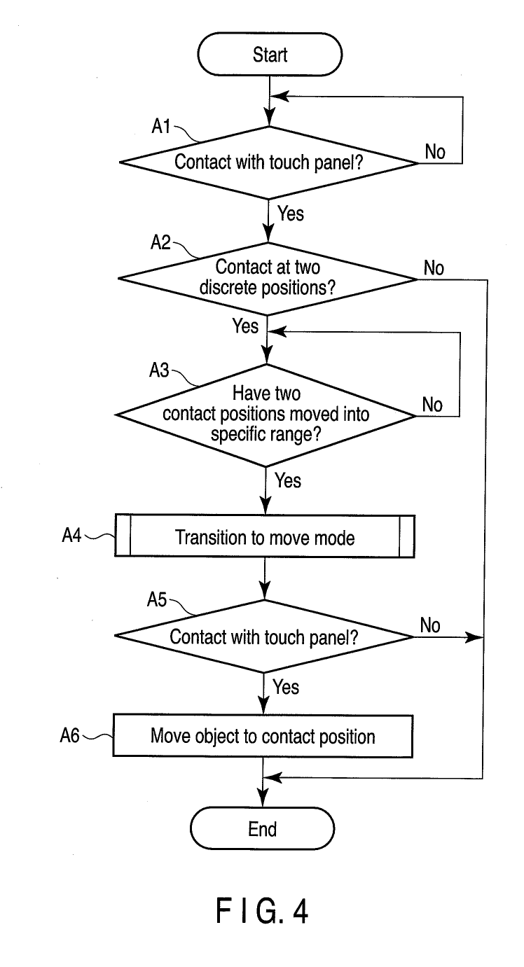

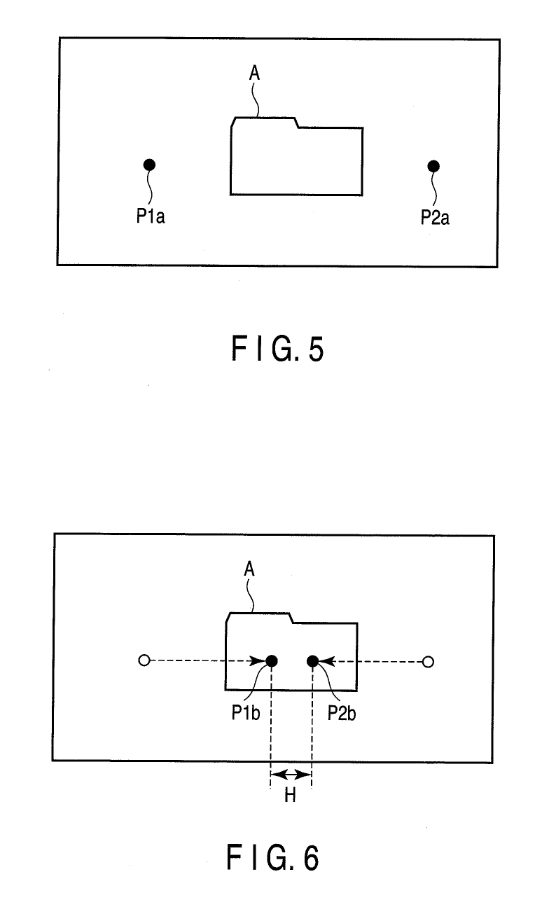

FIG. 4 is a flow chart illustrating the process of setting the process mode by the first method. FIG. 5 shows an example of an icon A representing a folder, which is displayed on the LCD 14.

Assume that the user has touched the touch panel 15 by the thumb and the forefinger, for example, in accordance with the position of the icon A displayed on the LCD 14, thereby to pinch the icon A by the thumb and the forefinger.

In this case, the contact detection module 203 detects contact at two positions on the touch panel 15 (Yes in block A1). The operation determination module 204a determines whether the distance between the two contact positions on the touch panel 15, which have been detected by the contact detection module 203, is a predetermined value or more. For example, this predetermined value is set at a value greater than the maximum width of the object (e.g. icon) that is the target of processing. Alternatively, the predetermined value may be set at an upper limit of the distance between the two contact positions. For example, a value indicative of a distance, at which no operation can be performed with the user's fingers, is set, and if contact is detected at two positions, the distance between which is greater than this value, this contact is determined to be invalid.

If contact at two discrete positions is detected (Yes in block A2), the operation determination module 204a monitors whether the two contact positions are moved into a specific range.

FIG. 5 shows two contact positions (points P1a and P2a) which are input in association with the icon A. The point P1a corresponds to, for example, the contact position of the thumb, and the point P2a corresponds to the contact position of the forefinger.

If the user performs a pinching operation while keeping the thumb and forefinger in contact with the touch panel 15, that is, an operation of bringing the thumb and forefinger close to each other, the point P1a, which is detected by the contact detection module 203, is moved to a point P1b, and the point P2a is moved to a point P2b, as shown in FIG. 6.

The operation determination module 204a determines whether the two contact positions of the points P1b and P2b are moved to within the distance of a predetermined value H and the object that is the target of the move process is present at the positions of the points P1b and P2b. The operation determination module 204a inquires of the OS 200 as to whether the object is present at the moved position of the point P1b or point P2b. Even if the point P1b or point P2b does not agree with the display position of the icon A, the OS 200 determines that the object is present if the point P1b or point P2b is near the icon A.

If the presence of the object (icon A in this example) is reported from the OS 200 (Yes in block A3), the mode setting module 205 sets the move mode for the icon A (block A4).

The OS 200 changes the display mode (e.g. display color) of the icon A displayed on the LCD 14, so that the user may recognize that the move mode has been set by the mode setting module 205.

If contact with the touch panel 15, 17 is detected by the contact detection module 203 after the move mode is set (Yes in block A5), the OS 200 executes a process of moving the display position of the icon A, for which the move mode has been set, to the position detected by the contact detection module 203 (block A6). For example, if the finger is put in contact with the touch panel 17 after the move mode is set for the icon A, the icon A is moved to the display position on the LCD 16 corresponding to the contact position on the touch panel 17.

If a position of a destination of move is not designated after the move mode is set (No in block A5), the mode setting module 205 cancels the move mode. For example, if there is no contact with the touch panel 15, 17 over a predetermined time or more (e.g. 5 seconds or more) after the move mode is set, the move mode is canceled.

In this manner, in the first method, the move mode can be set by performing the pinching operation designating the two positions on the touch panel 15 in accordance with the display position of the icon A displayed on the LCD 14. After the move mode is set, the position of the destination of move can be designated by simply touching the touch panel 17. Specifically, even when it is necessary to successively perform, on the two touch panels 15 and 17, an operation of designating the object (icon A) that is the target of move and an operation of designating the position of the destination of move, there is no need to perform an operation of displaying a command menu and designating a command, and therefore the good operability can be provided.

In the meantime, the position of the destination of move of the icon A, for which the move mode is set, can be designated not only on the touch panel 17, but also on the touch panel 15 as a matter of course.

(2) Method (second method) in which the process mode is set by an operation of selecting an object continuously for a predetermined time period.

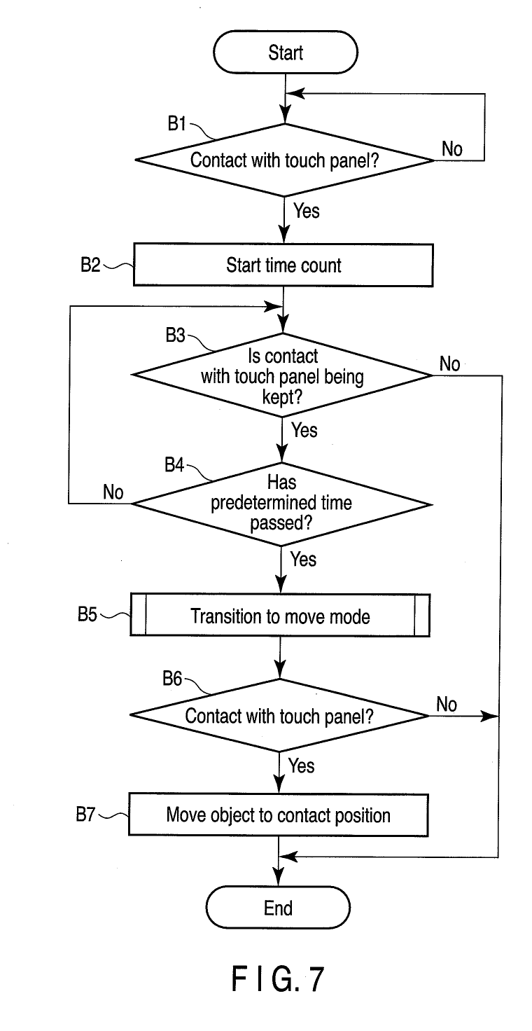

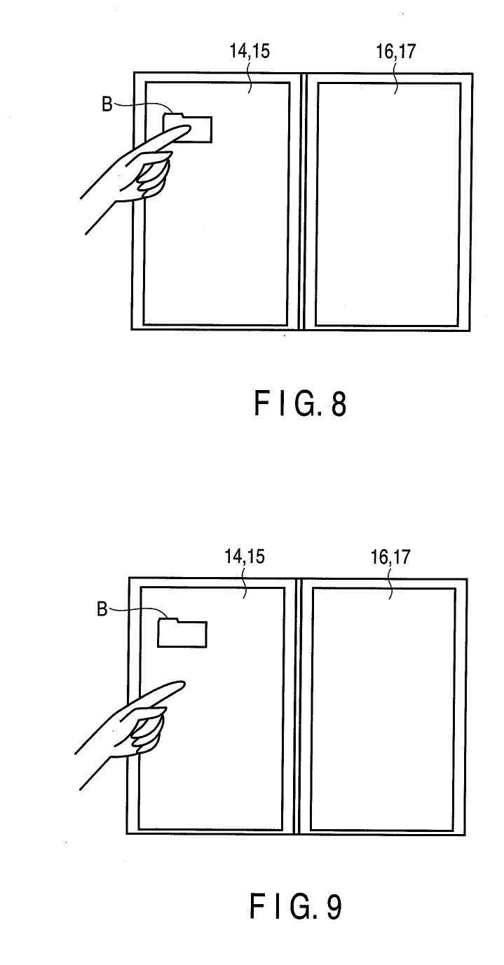

FIG. 7 is a flow chart illustrating the process of setting the process mode by the second method. FIG. 8 to FIG. 11 show display examples of an icon on the LCD 14, 16 for describing the second method.

Assume that the user has touched the touch panel 15 in accordance with the position of an icon B displayed on the LCD 14. The contact detection module 203 detects contact with the touch panel 15 (Yes in block B1).

The time determination module 204b inquires of the OS 200 as to whether an object is present at the position detected by the contact detection module 203. If the presence of the object (icon B in this example) is reported from the OS 200, the time determination module 204b starts time count in order to measure the time period in which the user continuously selects the icon B (block B2).

If the contact at the position corresponding to the icon B on the touch panel 15 is continued (Yes in block B3), the time determination module 204b determines whether a predetermined time (e.g. two seconds) has passed. If it is determined that the predetermined time has passed, the mode setting module 205 sets the move mode for the icon B (block B5).

The OS 200 changes the display mode (e.g. display color) of the icon B displayed on the LCD 14, so that the user may recognize that the move mode has been set by the mode setting module 205.

For example, as shown in FIG. 8, by putting the finger in contact with the icon B for a predetermined time or more, the move mode is set for the icon B. FIG. 9 shows the state in which a transition has occurred to the move mode. As shown in FIG. 9, with the move mode being set, the position of the destination of move can arbitrarily be designated.

As regards the process (blocks B5 to B7) after the move mode is set, the same process as in blocks A4 to A6, which has been described in connection with the first method, is executed, so a detailed description of the process (blocks B5 to B7) is omitted.

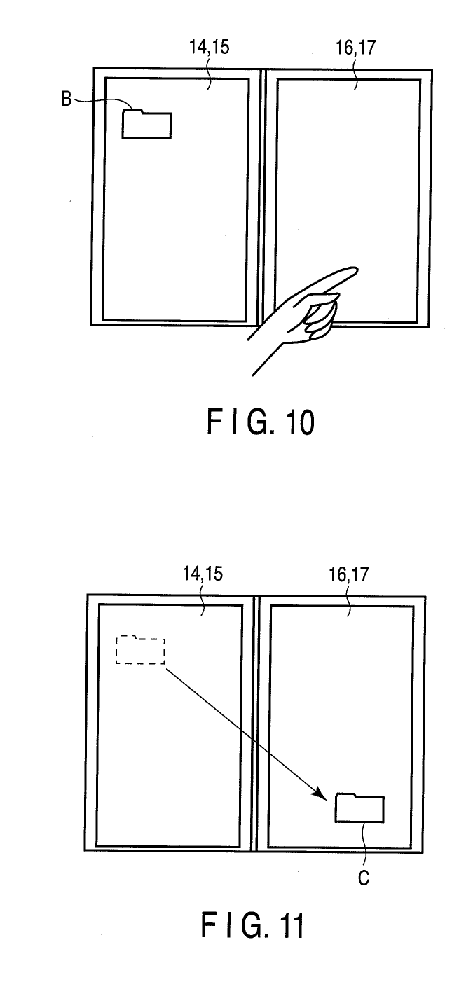

FIG. 10 shows the state in which the touch panel 17 is touched at the position of the destination of move of the icon B. The OS 200 displays an icon C after move, as shown in FIG. 11, at the display position on the LCD 16 corresponding to the contact position.

In this manner, in the second method, the move mode can be set simply by continuously selecting the icon B that is the target of processing for a predetermined time or more (i.e. by continuously touching the touch panel 15). The same operability as in the first method can be provided.

(3) Method (third method) in which the process mode is set based on the area of contact with the touch panel by an operation of selecting an object.

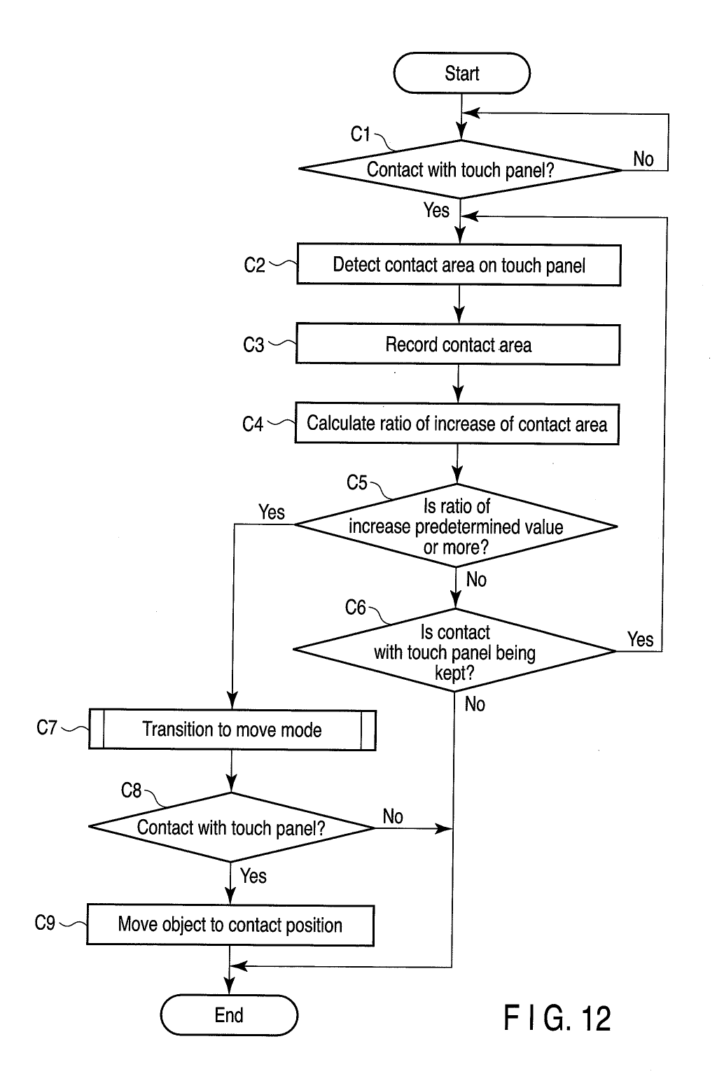

FIG. 12 is a flow chart illustrating the process of setting the process mode by the third method. Assume that the user has touched the touch panel 15, for example, in accordance with the position of an icon displayed on the LCD 14. The contact detection module 203 detects contact with the touch panel 15 (Yes in block C1).

The contact area determination module 204c inquires of the OS 200 as to whether an object is present at the position detected by the contact detection module 203. If the presence of the object is reported from the OS 200, the contact area determination module 204c detects the area of contact with the touch panel 15, for example, at regular time intervals (e.g. at every 0.5 second) (block C2).

The contact area determination module 204c records the detected contact area (block C3). The contact area determination module 204c compares the presently detected contact area with the contact area (default: 0) which was recorded by the previous detection, thereby calculating the ratio of increase of the contact area (block C4).

When the ratio of increase is not a predetermined or more (No in block C5), if the contact with the touch panel 15 is detected by the contact detection module 203 (Yes in block C6), the contact area determination module 204c repeatedly executes the detection of the contact area at regular time intervals and the calculation of the ratio of increase of the contact area, in the same manner as described above (blocks C2 to C6).

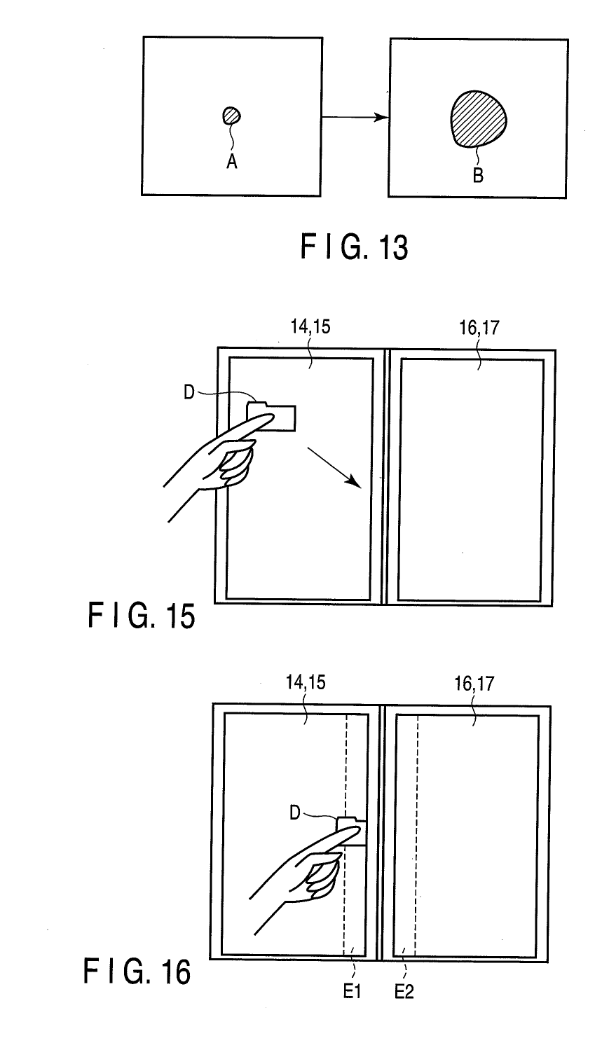

For example, when the touch panel 15 is touched by the fingertip in order to select the icon displayed on the LCD 14, the contact area A is narrow, as indicated by (A) FIG. 13. Then, by pressing the touch panel 15 by the ball of the finger, the contact area B becomes larger, as indicated by (B) in FIG. 13.

If the contact area determination module 204c determines that the ratio of increase of the contact area with the touch panel 15 is the predetermined value or more, the mode setting module 205 sets the move mode for the object (icon) corresponding to the contact position (block C7).

The OS 200 changes the display mode (e.g. display color) of the object (icon) displayed on the LCD 14, so that the user may recognize that the move mode has been set by the mode setting module 205.

As regards the process (blocks C7 to C9) after the move mode is set, the same process as in blocks A4 to A6, which has been described in connection with the first method, is executed, so a detailed description of the process (blocks C7 to C9) is omitted.

In this manner, in the third method, the move mode can be set simply by varying the contact state on the object (icon, etc.) that is the target of processing, so that the contact area may become larger than the contact area at the time of first contact. The same operability as in the first method can be provided.

In the above description, the move mode is set when the ratio of increase of the contact area on the touch pad 15 is the predetermined value or more. Alternatively, the move mode may be set when the contact area on the touch panel 15 is merely the predetermined value or more.

(4) Method (fourth method) in which the process mode is set by an operation of moving an object to a specific area (range).

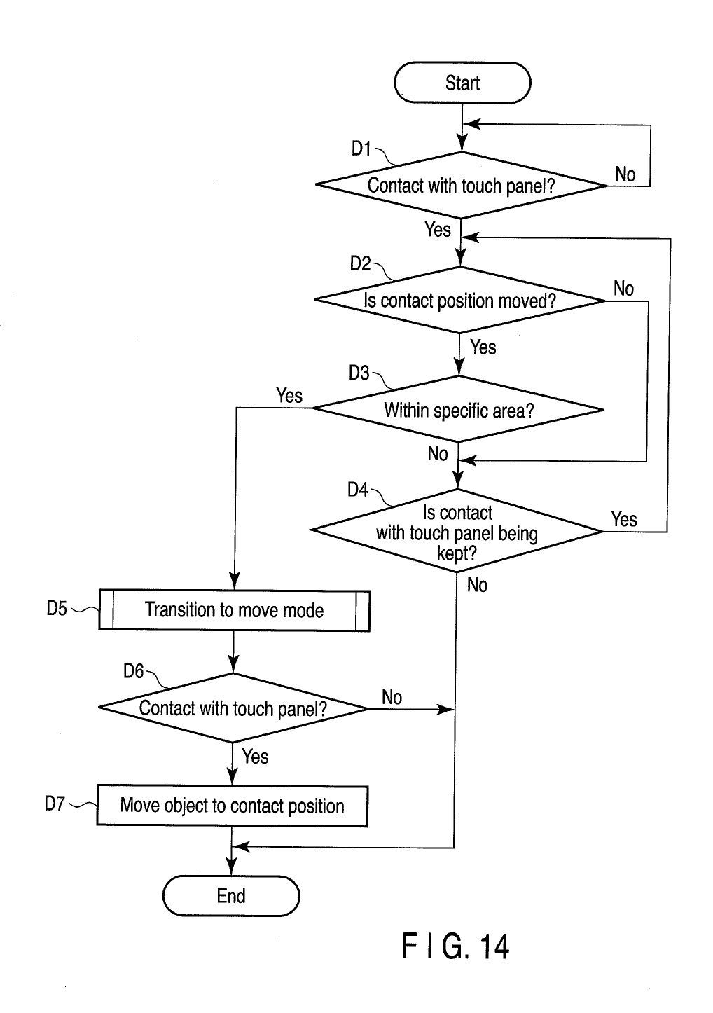

FIG. 14 is a flow chart illustrating the process of setting the process mode by the fourth method. FIG. 15 and FIG. 16 show display examples of an icon on the LCD 14 for describing the fourth method.

Assume that the user has touched the touch panel 15, for example, in accordance with the position of an icon D displayed on the LCD 14. The contact detection module 203 detects contact with the touch panel 15 (Yes in block D1).

The movement area determination module 204d inquires of the OS 200 as to whether an object is present at the position detected by the contact detection module 203. If the presence of the object (icon D) is reported from the OS 200, the movement area determination module 204d determines whether a position, at which the touch panel 15 is touched in order to select the icon D, is moved while the touch panel 15 is being touched, and is moved into a specific area which is set on the touch panel 15 (blocks D2 to D4). Specifically, the position at which the icon D is selected is moved into the specific area by a drag operation.

If it is determined that the position at which the icon D is selected is moved into the specific area (Yes in block D3), the mode setting module 205 sets the move mode for the icon D corresponding to the contact position (block D5).

The OS 200 changes the display mode (e.g. display color) of the object (icon) displayed on the LCD 14, so that the user may recognize that the move mode has been set by the mode setting module 205.

As regards the process (blocks D5 to D7) after the move mode is set, the same process as in blocks A4 to A6, which has been described in connection with the first method, is executed, so a detailed description of the process (blocks D5 to D7) is omitted.

FIG. 15 shows the state in which the icon D is selected and dragged. The movement area determination module 204d determines whether the contact position at which the icon D is selected is moved to a specific area El which is set on the touch panel 15, as shown in FIG. 16.

In the example shown in FIG. 16, the specific area El is set on the touch panel 15 along a side at which the touch panel 15 is coupled to the LCD 16 (touch panel 17). A specific area E2 is set on the touch panel 17 along a side at which the touch panel 17 is coupled to the LCD 14 (touch panel 15).

Thereby, in order to move the icon D displayed on the LCD 14 to the display area of the LCD 16, the drag operation is performed toward the LCD 16. Thus, the icon D can be made to reach the specific area E1. In other words, the move mode can be set by performing a conventional drag operation for moving the display position of the icon.

The specific areas E1 and E2 are shown in FIG. 16 by way of example. Such specific areas can be set at arbitrary locations on the touch panels 15 and 17.

A plurality of specific areas, which are independent in association with process modes, may be set on the touch panels 15 and 17. For example, a specific area for setting the move mode and a specific area for setting the copy mode are provided. Thereby, the process mode can be set in accordance with the specific area to which the object is to be moved.

In this manner, in the fourth method, the move mode can be set by performing the operation of moving the object (icon, etc.) that is the target of processing to the specific area E1, E2 set on the touch panel 15, 17. The same operability as in the first method can be provided.

(5) Method (fifth method) in which the process mode is set by an operation with a pressure of a predetermined value or more on the touch panel 15, 17.

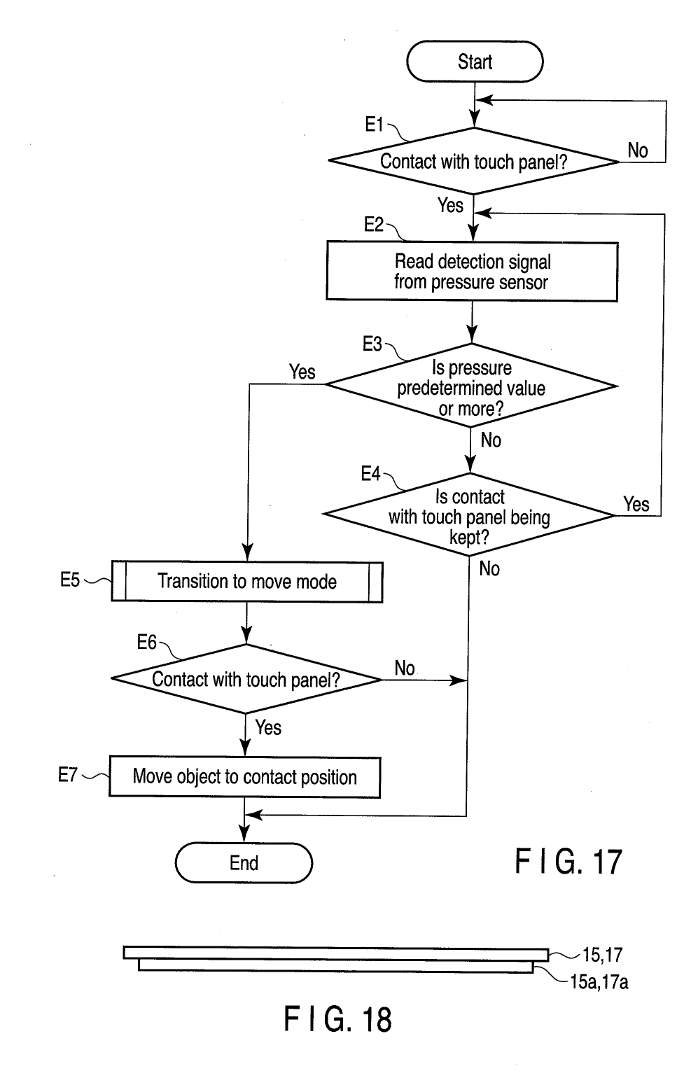

FIG. 17 is a flow chart illustrating the process of setting the process mode by the fifth method. In order to realize the setting of the process mode by the fifth method, the personal computer 10 includes the touch panels 15 and 17 which are equipped with pressure sensors 15a and 17a.

FIG. 18 is a side view of the touch panel 15, 17 which is equipped with the pressure sensor 15a, 17a. As shown in FIG. 18, since the pressure sensor 15a, 17a is attached in close contact with the touch panel 15, 17, the pressure of contact with the touch panel 15, 17 can be detected by the pressure sensor 15a, 17a.

Assume that the user has touched the touch panel 15, for example, in accordance with the position of an icon displayed on the LCD 14. The contact detection module 203 detects contact with the touch panel 15 (Yes in block E1).

The movement area determination module 204d inquires of the OS 200 as to whether an object is present at the position detected by the contact detection module 203. If the presence of the object (icon D) is reported from the OS 200, the pressure determination module 204e reads a detection signal from the pressure sensor 15a, 17a (block E2), and determines whether the pressure is a predetermined value or more (blocks E2 to E4).

If the user touches the touch panel 15 with a pressure for selecting the icon, the pressure determination module 204e determines whether the pressure detected by the pressure sensor 15a, 17a is a predetermined value or more (Yes in block E3). The mode setting mode 205 sets the move mode for the icon corresponding to the contact position (block E5).

The OS 200 changes the display mode (e.g. display color) of the object (icon) displayed on the LCD 14, so that the user may recognize that the move mode has been set by the mode setting module 205.

As regards the process (blocks E5 to E7) after the move mode is set, the same process as in blocks A4 to A6, which has been described in connection with the first method, is executed, so a detailed description of the process (blocks E5 to E7) is omitted.

In this manner, in the fifth method, the move mode can be set by performing the operation with a pressure of a predetermined value or more on the touch panel 15, 17. The same operability as in the first method can be provided.

The above first to fifth methods have been described as methods for setting the move mode for the icon. Alternatively, different process modes may be set in accordance with the first to fifth methods. For example, when the operation by the first method is performed, the move mode is set, and when the second method is performed, the copy mode is set. Other process modes are set in accordance with the other methods. In this case, for example, by the process of a utility program, the user may designate, in advance, which process mode is set by which method.

In the above description, the process mode is set by the touch panel driver 202. Alternatively, the OS 200 may determine the user's operation on the touch panel 15, 17, based on the coordinate data detected by the touch panel driver 202, and may set the process mode corresponding to the determined user's operation. Besides, based on the coordinate data detected by the touch panel driver 202, the application program 201 may set the process mode, and the process corresponding to the process mode may be executed in the OS 200 or application program 201.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
first and second display devices;
a first touch panel laid over the first display device;
a second touch panel laid over the second display device;
a detection module configured to detect a predetermined operation of moving a first position and a second position, at which the first touch panel is touched, to a position corresponding to the object displayed on the first display device, such that a distance between the first position and the second position is shorter than a predetermined distance;
a setting module configured to set a moving mode for moving a display position of the object when the predetermined operation is detected by the detection module; and
a display module configured to display the object on the display position on the second display device, which corresponds to an operation position of the second touch panel in accordance with an operation on the second touch panel after the moving mode is set.

2. The electronic apparatus of claim 1, wherein the detection module is configured to detect a predetermined operation in which a position of contact with the first touch panel is a position corresponding to the object displayed on the first display device, and a time period of the contact is a predetermined time or longer.

3. The electronic apparatus of claim 1, wherein the detection module is configured to detect a predetermined operation in which a position of contact with the first touch panel is a position corresponding to the object displayed on the first display device, and an area of the contact is a predetermined value or more.

4. The electronic apparatus of claim 1, wherein the detection module is configured to detect a predetermined operation in which the first touch panel is touched at a first position corresponding to the object displayed on the first display device, and the first position is moved, while the touch is sustained, to a second position on the first touch panel within a predetermined range of the first position.

5. The electronic apparatus of claim 1, further comprising a pressure sensor configured to detect a pressure of contact with the first touch panel,
wherein the detection module is configured to detect a predetermined operation in which a position of contact with the first touch panel is a position corresponding to the object displayed on the first display device, and the pressure of contact detected by the pressure sensor is a predetermined value or more.

6. An electronic apparatus comprising:
a display device;
a touch panel laid over the display device;
a detection module configured to detect an operation of moving a first position and a second position, at which the touch panel is touched, to a position corresponding to the object displayed on the display device, such that a distance between the first position and the second position is shorter than a predetermined distance;
a setting module configured to set a moving mode for moving a display position of the object when the operation is detected by the detection module;
an input module configured to input a display position of the object in accordance with the operation on the touch panel after the moving mode is set; and
a display module configured to display the object on the display in accordance with the display position input by the input module.

7. The electronic apparatus of claim 6, wherein the detection module is configured to detect an operation in which a position of contact with the touch panel is a position corresponding to the object displayed on the display device, and a time period of the contact is a predetermined time or longer.

8. The electronic apparatus of claim 6, wherein the detection module is configured to detect an operation in which a position of contact with the touch panel is a position corresponding to the object displayed on the display device, and an area of the contact is a predetermined value or more.

9. The electronic apparatus of claim 6, wherein the detection module is configured to detect an operation in which the touch panel is touched at a first position corresponding to the object displayed on the display device, and the first position is moved, while the touch is sustained, to a second position on the touch panel within a predetermined range of the first position.

10. The electronic apparatus of claim 6, further comprising a pressure sensor configured to detect a pressure of contact with the touch panel,
wherein the detection module is configured to detect an operation in which a position of contact with the touch panel is a position corresponding to the object displayed on the display device, and the pressure of contact detected by the pressure sensor is a predetermined value or more.
